(19) United States
(12) Patent Application Publication
(10) Pub. No.: US 2010/0131346 A1
(43) Pub. Date: May 27, 2010

(54) Method And System For Associating A Seller With Purchased Digital Content

(76) Inventors: Robert J. MORGAN, San Rafael, CA (US); Christopher K. HESS, San Francisco, CA (US); Daniel J. LIN, San Francisco, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/324,252

(22) Filed: Nov. 26, 2008

(51) Int. Cl. G06Q 30/00; G06Q 10/00; G06Q 50/00

(52) U.S. Cl. 705/14.25; 705/30; 705/26

(57) ABSTRACT

An digital content management system provides a web interface for a user to purchase digital content from an online digital content store. The system is able to track the purchased digital content and deliver marketing content from the online digital content store when a user selects the purchased digital content for consumption through the web interface.

### BACKGROUND OF THE INVENTION

Current online digital music stores such as Amazon MP3, Walmart.com, and Rhapsody provide Internet users the ability to discover and purchase full-track digital music downloads through a web service. In a standard purchase scenario, a user visits one of these websites, browses the site's music catalog and purchases a digital song which is then downloaded to the user's PC during the purchase process. From that point onward, the user may use one of several music players residing on his PC to listen to the song. Examples of such music players are iTunes and Windows Media Player. Often, the digital format of the purchased music is a well recognized standard, such as MP3, that is free of digital rights management (DRM) protections such that the playing of such purchased music can be easily implemented by any third party application developer.

In one typical situation, a user may purchase a digital song from a seller such as Amazon MP3 and ultimately play the song using a competitor's PC-based music player such as iTunes. In such a situation, iTunes is able to offer advertising and other marketing content and services through its PC-based music player interface to the user in an effort to lure the user to its own iTunes Music Store and away from Amazon MP3. As demonstrated by the foregoing situation, after content is purchased by a user, the digital content is disassociated from the online store during consumption of the content, allowing other competitors with complementary offerings (i.e., a popular music player, etc.) to gain market share by luring the user away by marketing the user through the complementary offering.

### SUMMARY OF THE INVENTION

One or more embodiments of the present invention provides a system that offers a web based interface for managing digital content that provides marketing opportunities to a seller of digital content, such as Amazon MP3, even after the sale of such digital content, and particularly during a user's management of such digital content through the web based interface. By facilitating a purchase transaction for the seller through the web based interface, the system is able to establish and record an association between the purchased digital content and the seller during consummation of the purchase transaction. When the user subsequently accesses such purchased content through the web based interface, the system is able to deliver marketing content of the seller to the user through the web based interface.

A method, according to an embodiment of the invention, provides for associating a seller of digital content with the digital content during its consumption by a user. The method comprises enabling access to a digital content store owned by the seller through a web interface for managing digital content, tracking a purchase of digital content from the digital content store, and displaying marketing content relating to the seller through the web interface upon selection of the digital content through the web interface by the user for consumption.

### BRIEF DESCRIPTION OF THE DRAWINGS

FIG. 1 depicts a web based interface for managing digital content that may be used in an embodiment of the present invention.

FIG. 2 depicts a online digital content store accessed through the web based interface.

FIG. 3 depicts the web based interface upon a selection of digital content purchased through the online digital content store.

FIG. 4 depicts an architecture of an online digital content management system in accordance with one embodiment of the present invention

FIG. 5 depicts a flow chart for purchasing digital content in accordance with an embodiment of the present invention.

FIG. 6 depicts an exemplary record with a seller identification field for a purchased digital song in accordance with the present invention.

FIG. 7 depicts a flow chart for consuming digital content in accordance with an embodiment of the present invention.

### DETAILED DESCRIPTION

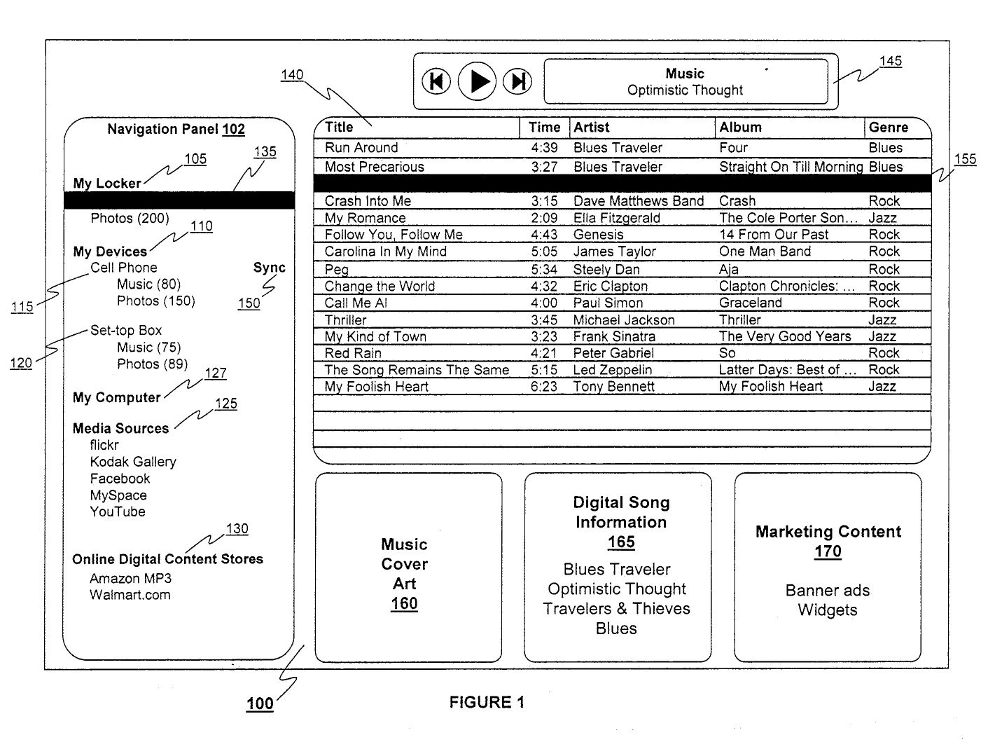

FIG. 1 depicts a web based interface 100 for managing digital content that may be served by an online digital content management system in an embodiment of the present invention. A navigation panel 102 enables a logged in user to select and view a variety of collections of digital content (e.g., music, photos, video, other rich-media and multimedia formats, etc.), including digital content stored or otherwise managed by the management system in a locker 105, digital content stored in the user's various devices 110 such as cell phone 115 and set top box 120, as well as any of a number of third party web services that may be used as media sources 125 by the user to store or otherwise manage digital content. The user can further make a selection to navigate his computer 127 to find locally stored digital content and select a number of online digital content stores 130 to discover new digital content for purchase.

As depicted in FIG. 1, a user has chosen to view music 135 in his locker 105. Selection of music 135 causes the user's digital music collection that is stored (or managed) by the management system to be presented in display window 140. By selecting one of the digital songs in display window 140, the user can consume the digital song in a number of ways, for example, by playing it in digital music player 145 or by dragging and dropping it into cell phone 115 and pressing the sync link 150 to deliver the song to the cell phone. A number of other digital content consumption activities may be available through the web interface, depending upon the type of digital content and the design of the web interface, including viewing the digital content (e.g., photos), downloading the digital content to a local data store, dragging and dropping the content to other devices 110 or media sources 125, streaming the digital content from a remote data store, and any other digital content management activities. As depicted in FIG. 1, selecting one of the digital songs in display window 140, such as “Optimistic Thought” 155, causes the digital song's cover art to be displayed in cover art window 160 and the song's metadata information (e.g., artist, album, title, genre, etc.) to be displayed in song information window 165. Additionally, the web based interface of FIG. 1 also has an advertisement window 170 to serve ads and other marketing content to the user.

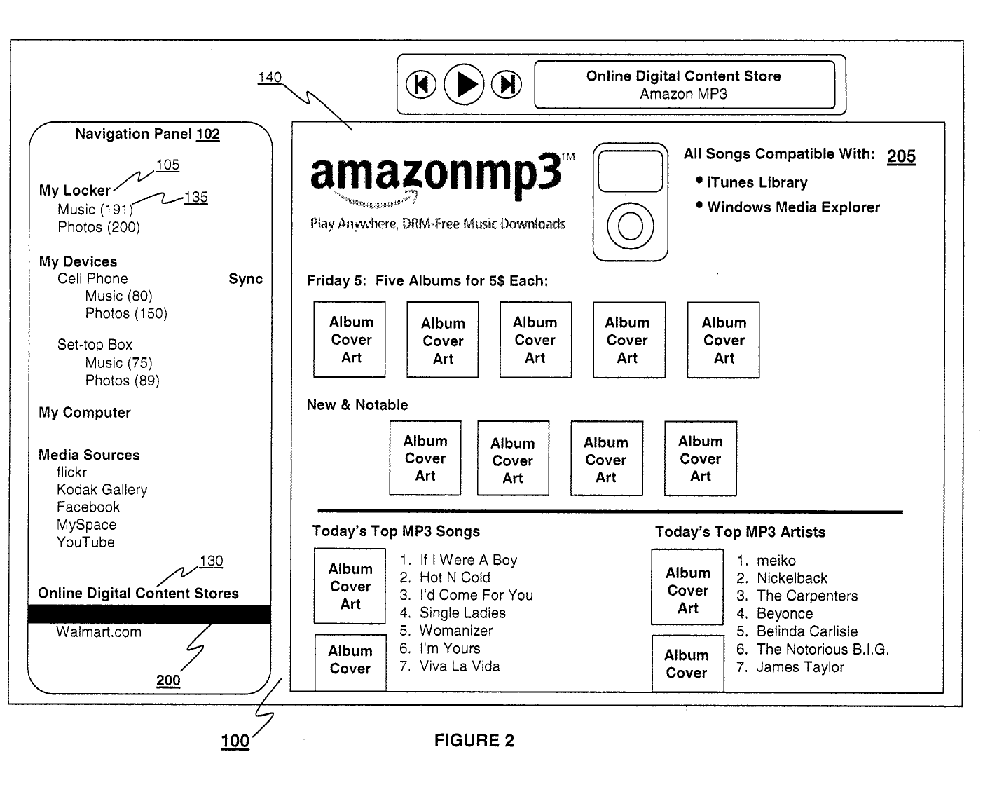

FIG. 2 depicts the web interface of FIG. 1 when the user has selected one of the online digital content stores 130, in particular, store 200 (i.e., Amazon MP3). Selection of store 200 in navigation panel 102 causes display window 140 to display a web page 205 for store 200. In the embodiment of FIG. 2, for example, display window 140 is an inline frame that enables a user to navigate the various pages of store 200 (starting from web page 205) similar to a standalone web browser. A user navigating through the web pages of store 200 in display window 140 can ultimately consummate a purchase transaction with store 200 for digital content through display window 140, resulting in the purchased digital content being stored in the user's music collection 135 of his locker 105.

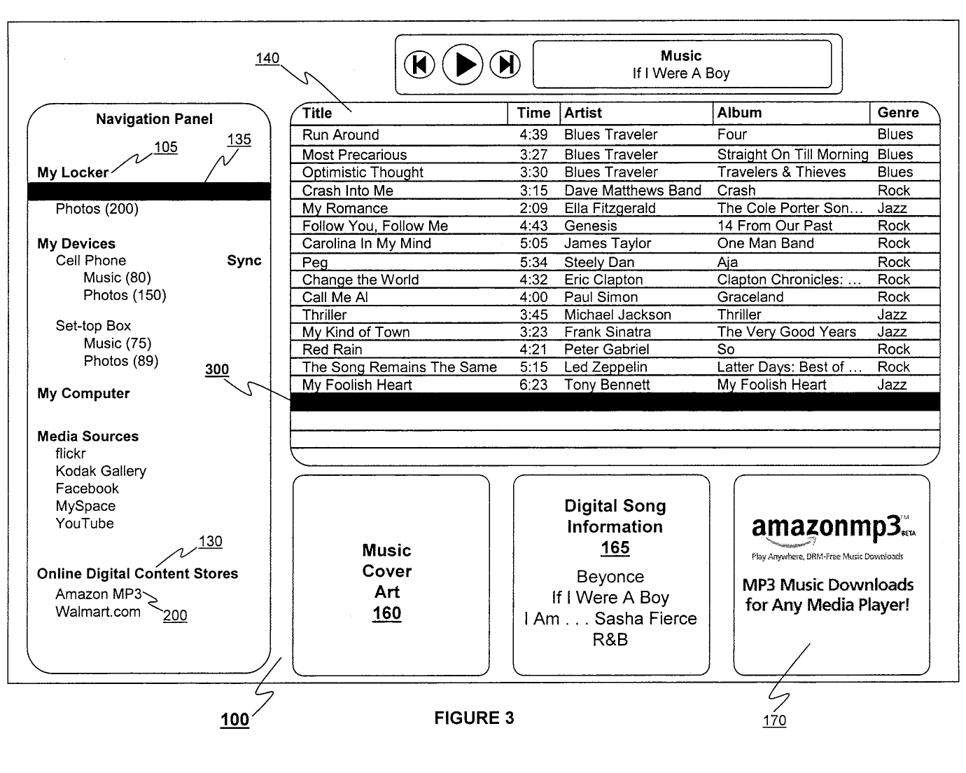

As depicted in FIG. 3, after purchasing a digital song 300 from store 200 (i.e., Beyonce's “If I Were A Boy”) in display window 140 of FIG. 2, digital song 300 is stored in the user's music collection 135 of locker 105 such that selecting music collection 135 cause digital song 300 to appear as part of the list of songs displayed in display window 140. Upon selecting song 300 in display window 140, in addition to digital song's 300 cover art and song information being displayed in cover art window 160 and song information window 165, respectively, marketing content corresponding to store 200 is displayed in advertisement window 170. Such marketing content can include advertisement banners, interactive widgets, marketing videos, animations and any other type of marketing content known to those with ordinary skill in the art.

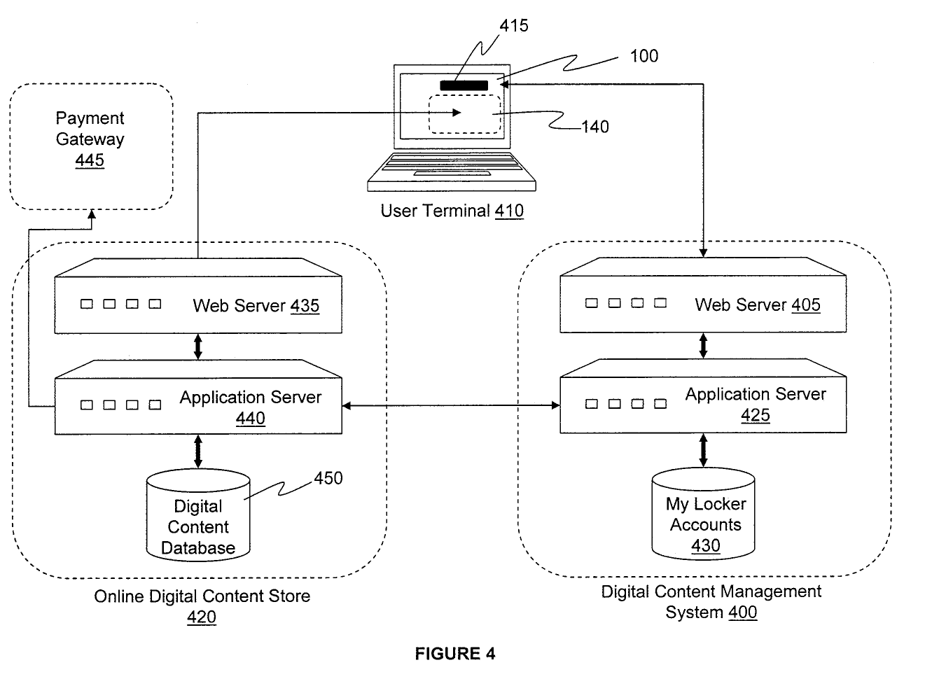

FIG. 4 depicts an architecture of one embodiment of an online digital content management system 400 in accordance with the present invention. Web server 405 of system 400 serves web interface 100 to a web browser at a user's terminal 410. In the embodiment of FIG. 4, the web browser of the user's terminal 410 has an installed plug-in 415, such as an ActiveX control plug-in or browser extension, that is used to faciliate communication between management system 400 and online digital content store 420 through the web browser. Management system 400 further includes an application server 425 that handles actions performed by a user through web interface 100 to manage his digital content, for example, by adding, deleting or otherwise modifying the digital content stored in the user's locker account in locker data store 430.

As previously discussed in the context of FIG. 2, in one embodiment of the present invention, display window 140 of web interface 100 receives web pages served by web server 435 of online digital content store 420. Upon completing a purchase of digital content through web interface 100 at user terminal 410, application server 440 of online digital content store 420 interacts with payment gateway 445 to complete the purchase transaction. Once the purchase transaction is confirmed to be successful, application server 440 can extract the purchased digital content from digital content database 450 and transmit it to application server 425 of management system 400 for storage in the user's locker account in locker store 430.

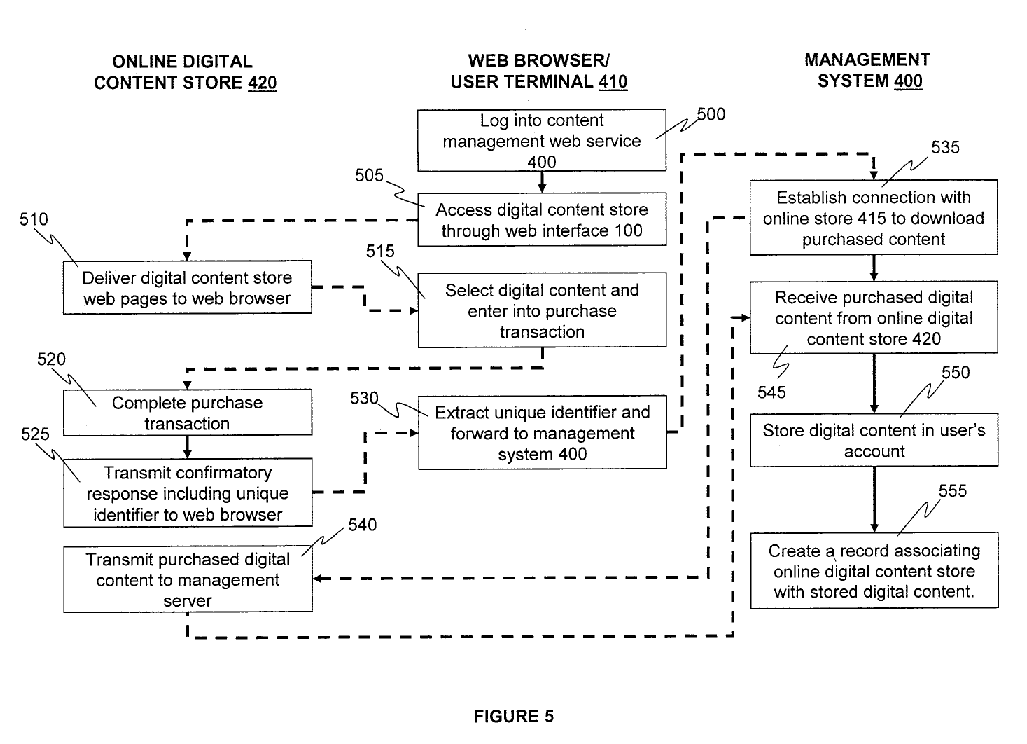

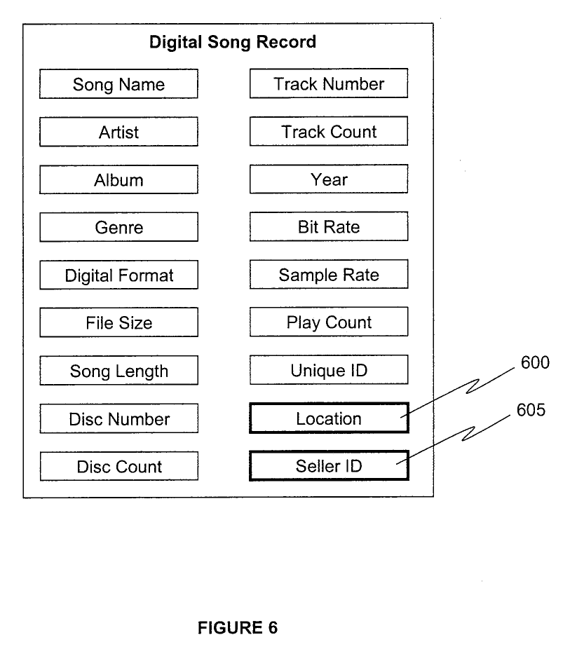

FIG. 5 is a flow chart that further details interaction among digital content management system 400, online digital content store 420 and the web browser of user terminal 410 during a purchase transaciton of digital content. In step 500, a user first logs into web interface 100 served by digital content management system 400 to the browser of user terminal 410. In step 505, the user accesses online digital content store 420 through web interface 100 (e.g., via display window 140 in an embodiment utilizing a web interface design similar to FIGS. 1-3). In step 515, the user selects a particular item of digital content to purchase (e.g., a digital song, etc.) and begins the purchase transaction, for example, by submitting payment modalities or otherwise permitting access to stored payment information in a user account at online digital content store 420. In step 520, online digital content store 420 interacts with payment gateway 445 to finalize the purchase transaction and once finalized, in step 525, transmits a confirmatory response to the web browser of user terminal 410. Such a confirmatory response may take any of a number of forms, including a web page confirming a successful purchase or any other message format that may be received by the web browser, including by plug-in 415. The confirmatory response contains a unique transaction identifier (e.g., receipt number, transaction code, etc.) corresponding to the successful purchase transaction. In step 530, the web browser at user terminal 415 receives the confirmatory response and plug-in 415 extracts the unique transaction identifier from the confirmatory response and transmits the unique transaction identifier to data content management system 400. Upon receipt of the unique transaction identifier, digital content management system 400 establishes a connection with online digital content store 420 in step 535, submits the unique transaction identifier to online digital content store 420 to identify the purchased digital content for download. In step 540, online digital content store 440 identifies the purchased digital content using the unique transaction identifier and transmits the purchased digital content to digital content management system 400. In step 545, digital content management system 400 receives the purchased digital content from online digital content store 440. In step 550, the received purchased digital content is stored in association with the user's account. The digital content may be stored locally in the digital content management system's 400 own storage, such as locker store 430 or may be stored at a remote location, for example, a third party online storage provider (e.g., whose content may be accessible through web interface 100 through a URL). In step 555, a record is created to store metadata relating to the stored digital content, including its location in storage and identifying information (e.g., ID number, etc.) corresponding to online digital content store 420. In an embodiment in which the purchased digital content is a digital song, the record may include further metadata fields such as title of song, artist, album, genre, song size, bitrate and any other metadata information relating to digital songs that are known to those with ordinary skill in the art. FIG. 6 depicts one embodiment of such a record where the purchased digital content is a digital song. As depicted, location field 600 indicates a location where the digital song is stored and may be in the form of a URL (Uniform Resource Locator). Seller ID field 605 uniquely identifies the seller of the digital song, for example, online digital store 420.

Those with ordinary skill in the art will recognized that variations on the flow, architecture and techniques as described in the context of FIGS. 4 and 5 may be made without departing from the spirit of the invention. For example, in an alternative embodiment, rather than using a plug-in 415 to forward communication between online digital content store 420 and digital content management system 400, the confirmatory response of step 525 may be a web page including a button or other web page control mechanisms (e.g., checkbox, radio buttons, other means of receiving input from the user through a web page, etc). The web page may provide the user the ability to download the purchased digital content to his personal computer and/or solicit the user to additionally download the digital content to the user's account at the digital content management system 400 by clicking the button. Clicking the button thereby submits a request including the unique transaction identifier to web server 405 of digital content management sysem 400 (e.g., a POST request, etc.) which then communicates with application server 425 to establish the connection with online digital content store 420 in step 535. In alternative embodiments, rather than sending the unique transaction identifier to user terminal 410 in step 525, online digital content store 420 may initiate a download transaction directly with digital content management system 400 or transmit an email to digital content management system 400, which, when received and parsed, triggers digital content management system 400 to initiate the download transaction. In yet another embodiment, rather than storing the purchased digital content in storage managed by digital content management system 400, the purchased digital content may be stored locally in the user's computer or at a third-party storage or backup web service, both of which may be accessible (i.e., viewable through a display window in web interface 100 similar to display window 140) through selection options of a navigation panel of web interface 100 (e.g., similar to navigation panel 102). In such an embodiment, the location field 600 of the related record (see FIG. 6) would properly reflect the off-site location of the purchased digital content.

In yet another alternative embodiment, the purchase of digital media by the user through web interface 100 is conducted through online digital content store's 420 standard purchase flow without communication with digital content management system 400. Upon completion of the purchase, online digital content store 420 provides a link to the purchased digital content to the web browser of user terminal 410 to enable the web browser to download the digital content to the local storage of user terminal 410 (e.g., hard drive, etc.). During the web browser's download process, plug-in 415 is able to intercept and record the location on user terminal's 410 local storage where the digital content is stored. Plug-in 415 forwards the recorded location to online digital content management 400 to create the record of step 555.

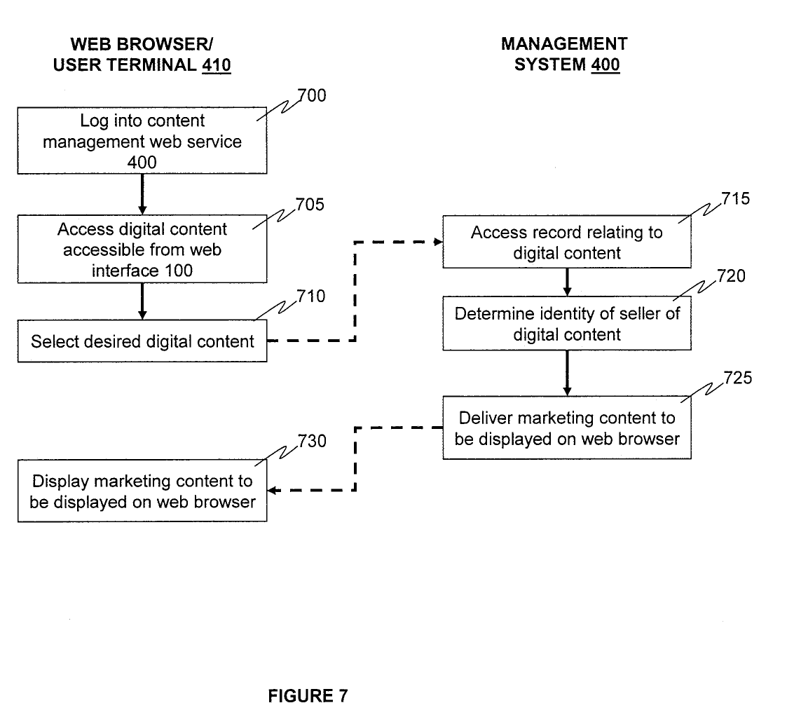

FIG. 7 is a flow chart detailing the association of a seller with digital content purchased from the seller when a user accesses the digital content through a web interface in accordance with the present invention. In step 700, the user logs into digital content management server 400 to access web interface 100. In step 705, the user is able to access digital content via the web interface 100 and in step 710, selects the desired digital content to consume, for example, through selection of an item in navigation panel 102 and then selecting the digital content in display window 140. In step 715, the selection action of the user is transmitted through the web browser to digital content management system 400 and digital content management system 400 accesses a record associated with the selected digital content (e.g., similar to the record of FIG. 6). In step 720, digital content management system 400 extracts a seller ID from the record to identify the online digital content store from which the selected digital content was purchased. In step 725, digital content management system 400 is then able to deliver marketing content relating to the seller to the web browser of user terminal 410, which in step 730 then displays such marketing content to the user through the web browser. Those with ordinary skill in the art will recognize numerous methods for delivering marketing content to user terminal 410, including, for example, delivering a banner ad or widget to an advertisement window or location in web interface 100, causing a pop-up window with marketing content to appear, embedding a link in a web page that enables the web browser to connect to a third party advertising delivery platform to obtain marketing content, or otherwise providing marketing content.

In yet another alternative embodiment, rather than associating a seller with purchased digital content by creating a record with a seller ID field, a seller ID is embedded into the purchased digital content itself. For example, in the case of a digital song, the seller ID may be inserted into certain headers of the digital song file depending upon the file's format, such as embedding such information in an ID3 tag for an MP3 file. Alternatively, the seller ID may be embedded through known watermarking or fingerprinting techniques. Similarly, marketing content may also be embedded directly into the digital song. For example, marketing content may be inserted as cover art in the digital song's format. Upon consumption of the digital content, the seller ID and/or marketing content is extracted directly from the digital content itself to be displayed, for example, through the web interface.

In yet another embodiment, digital content may be uploaded to or otherwise made available to digital content management system 400 (e.g., links for streaming, etc.) to offer to its users. For example, a music label may upload music (or otherwise provide a URL for downloading or streaming) to digital content management system 400 in order to offer its users for subscription or promotional purposes. When a user logged into digital content management system 400 subsequently selects such music for consumption (e.g., playback, streaming, preview, etc.), marketing material relating to the music label may be delivered to the user through the web interface. For example, a user may select from a catalog of digital content provided by digital content management system 400 to create a playlist, album or other collection. When the user subsequently accesses such playlist, digital content management system 400 delivers marketing content corresponding to the music label.

Those of ordinary skill in the art will additionally recognize that the control logic and data stored and used by the various software components as described in the foregoing specification are merely illustrative and may be redistributed through various other software components and databases in alternative but functionally equivalent designs, including the removal of certain software components and/or databases, without departing from the scope or spirit of the described embodiments. For example, those with ordinary skill in the art will recognize that the architecture of FIG. 4 depicts simplified versions of a digital content management system and online digital content store and that additional and/or alternative servers and/or data stores may be required in an actual implementation. Similarly, while the foregoing examples have used a web based interface and web browser as primary examples, those with ordinary skill in the art will recognize that other alternatives such as PC based applications which access the Internet to acquire information and content may be used in alternative embodiments. Terminology used in the foregoing description is for the purpose of describing the particular versions or embodiments only, and is not intended to limit the scope of the present invention which will be limited only by the appended claims. As used herein and in the appended claims, the singular forms “a,” “an,” and “the” include plural references unless the context clearly dictates otherwise. Similarly, the words “for example”, “such as”, “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention. Thus, various modifications, additions and substitutions and the like can be made without departing from the spirit of the invention and these are therefore considered to be within the scope of the invention as defined in the following claims.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

We claim:

1. A method for associating a seller of digital content with said digital content during consumption of said digital content by a user, the method comprising:
enabling access to a digital content store owned by the seller through a web interface for managing digital content;
tracking a purchase of digital content from the digital content store; and
displaying marketing content relating to the seller through the web interface upon selection of the digital content through the web interface by the user for consumption.

2. The method of claim 1, wherein the tracking step further comprises the steps of:
receiving a purchase action from the user through the web interface;
establishing a network connection with the digital content store; and
downloading the purchased digital content through the network connection.

3. The method of claim 2, further comprising the step of storing the purchased digital content at a location accessible through the web interface.

4. The method of claim 1, wherein the tracking step comprises:
recording a location where the purchased digital content is stored; and
enabling access to said location through the web interface.

5. The method of claim 4, wherein the location is a data store of a personal computer of the user.

6. The method of claim 1, further comprising the steps of:
creating a record associated the purchased digital content during said tracking step, wherein the record comprises an indicia of the seller and a location where the purchased digital content is stored; and
accessing the record upon said selection of the digital content by the user in order to identify the seller for said step of displaying marketing content relating to the seller.

7. The method of claim 1, further comprising the steps of:
embedding an indicia of the seller into the purchased digital content during said tracking step; and
extracting the indicia to identify the seller for said step of displaying marketing content relating to the seller.

8. A computer system for associating a seller of digital content with said digital content during consumption of said digital content by a user, the computer system comprising:
a data store for storing digital content purchased by the user.
a processor programmed to: (i) serve a web interface to a web browser for accessing digital content stored in the data store, (ii) receive an identifier from the web browser, wherein the identifier corresponds to digital content purchased by the user by accessing a digital content store through the web interface, (iii) transmit the identifier to the digital content store, (iv) download the digital content from the digital content store, and (v) associate with the downloaded digital content a seller identifier corresponding to the digital content store.

9. The computer system of claim 8, wherein the seller identifier is embedded into the downloaded digital content.

10. The computer system of claim 8, wherein associating the seller identifier with the downloaded digital content comprises generating a record comprising a seller identifier field and associating it with the downloaded digital content.

11. The computer system of claim 8, wherein the processor is further programmed to: (i) receive a selection of digital content from the user through the web interface, (ii) access a record corresponding to the selected digital content, (iii) extract a seller identifier from the record, and (iv) deliver marketing content relating to the seller identifier to the web browser for display to the user.

12. The computer system of claim 8, wherein the processor is further programmed to: (i) receive a selection of digital content from the user through the web interface, (ii) extract a seller identifier from the selected digital content, and (iii) deliver marketing content relating to the seller identifier to the web browser for display to the user.

13. The computer system of claim 8, wherein the received identifier is transmitted from a plug-in of the web browser.

14. The computer system of claim 8, wherein the received identifier is embedded in a message transmitted by the web browser as a result of a clicking of a button by the user.

15. A computer readable storage medium having stored therein a computer program for associating a seller of digital content with said digital content during consumption of said digital content by a user, wherein a computer system executing the computer program carries out the steps of:
enabling access to a digital content store owned by the seller through a web interface for managing digital content;
tracking a purchase of digital content from the digital content store; and
displaying marketing content relating to the seller through the web interface upon selection of the digital content through the web interface by the user for consumption.

16. The computer readable storage medium of claim 15, wherein the computer system executing the computer program further carries out the steps of:
receiving a purchase action from the user through the web interface;
establishing a network connection with the digital content store; and
downloading the purchased digital content through the network connection.

17. The computer readable storage medium of claim 16, wherein the computer system executing the computer program further carries out the step of storing the purchased digital content at a location accessible through the web interface.

18. The computer readable storage medium of claim 15, wherein the computer system executing the computer program further carries out the steps of:
recording a location where the purchased digital content is stored; and
enabling access to said location through the web interface.

19. The computer readable storage medium of claim 15, wherein the computer system executing the computer program further carries out the steps of:
creating a record associated the purchased digital content during said tracking step, wherein the record comprises an indicia of the seller and a location where the purchased digital content is stored; and
accessing the record upon said selection of the digital content by the user in order to identify the seller for said step of displaying marketing content relating to the seller.

20. The computer readable storage medium of claim 15, wherein the computer system executing the computer program further carries out the steps of:
embedding an indicia of the seller into the purchased digital content during said tracking step; and
extracting the indicia to identify the seller for said step of displaying marketing content relating to the seller.
